(19) United States
(12) Patent Application Publication
(10) Pub. No.: US 2024/0375951 A1
(43) Pub. Date: Nov. 14, 2024

(54) HYDROGEN PRODUCTION IN BUILT ENVIRONMENT

(71) Applicant: HiiROC-X Developments Limited, Tunbridge Wells (GB)

(72) Inventor: Ate Wiekamp, Tunbridge Wells (GB)

(73) Assignee: HiiROC-X Developments Limited, Tunbridge Wells (GB)

(21) Appl. No.: 18/690,621

(22) PCT Filed: Aug. 30, 2022
(86) PCT No.: PCT/GB2022/052218

§ 371 Date: Mar. 8, 2024

(30) Foreign Application Priority Data
Sep. 10, 2021 (GB) 2112954.9

(51) Int. Cl. C01B 3/24; C01B 32/05

(52) U.S. Cl. CPC C01B 3/24; C01B 32/05; C01B 2203/0272; C01B 2203/066; C01B 2203/0861; C01B 2203/1241; C01B 2203/84

(57) ABSTRACT

An energy provision system for and a method of operating a building or a system of buildings are described. Hydrocarbons from a hydrocarbon input are processed to produce a hydrogen gas output and a carbon solids output. The hydrogen gas output is provided to one or more hydrogen gas consumers for providing heating or power to the building or system of buildings. The carbon solids output is provided to a waste water system for removing contaminants or pollutants from waste water.

### FIELD OF INVENTION

The invention relates to hydrogen production in a built environment, for example a building or a collection of buildings.

### BACKGROUND TO INVENTION

Power and heating for buildings has primarily been provided by hydrocarbons in the form of oil and gas, but alternatives to this approach are being sought as use of hydrocarbons for such purposes is now being steadily reduced. Electricity provision is increasingly provided from renewable sources, but this is not always the most efficient approach—local power generation would often be desirable for control and for management of cost. Hydrogen is increasingly attractive for use as a fuel, as it releases energy very efficiently and without harmful waste products. Hydrogen boilers for use in buildings are currently entering production. Electricity can also be generated from hydrogen, for example using solid oxide fuel cells.

Processes have been developed to obtain hydrogen from hydrocarbons—this has typically been done up to now in large reactors which are not suitable for use within most built environments. It would be desirable to be able to provide hydrogen into a built environment in a way that did not rely on offsite creation of hydrogen and hydrogen delivery. It would be particularly desirable to do this in a way that enabled a hydrogen production system to be integrated as effectively as possible into a built environment.

### SUMMARY OF INVENTION

In a first aspect, the invention provides an energy provision system for a building or system of buildings, the system comprising: a hydrocarbon processing system adapted to provide a hydrogen gas output and a carbon solids output from a hydrocarbon input; wherein the hydrogen gas output is provided to one or more hydrogen consumers for providing energy; and the carbon solids output is provided to a waste water system for removing contaminants or pollutants from waste water.

This hydrocarbon processing system may comprise a pyrolysis reactor. The pyrolysis reactor may comprise a plasma torch reactor for processing hydrocarbons, wherein the plasma torch reactor has a hydrocarbon gas input and a hydrogen and carbon gas output; and a liquid metal system for receiving the hydrogen and carbon gas output from the plasma torch reactor, and for conveying the hydrogen and carbon to a separation system for providing the hydrogen gas output and the carbon solids output.

The benefits of using a liquid metal system in this way include the possibility of starting the plasma torch without need for contact or high-voltage ignition. The use of this approach also avoids carbon deposition as the carbon is carried through to the next stage of the system—this obviates the need for frequent cleaning of the torch.

The one or more hydrogen consumers may comprise a hydrogen-fired boiler, a fuel cell to provide electricity from a hydrogen input, or both. If a fuel cell is provided, an electrical system of the building or system of buildings may be configured such that electricity from the fuel cell may be provided to either the energy provision system, an electrical supply grid, or both. The hydrocarbon input may be a methane input.

In a second aspect, the invention provides a method of operating a building or a system of buildings, the method comprising: processing hydrocarbons from a hydrocarbon input to produce a hydrogen gas output and a carbon solids output; providing the hydrogen gas output to one or more hydrogen consumers for providing heating or power to the building or system of buildings; and providing the carbon solids output to a waste water system for removing contaminants or pollutants from waste water.

This approach is extremely effective for integration of hydrogen production in a built environment, as it can provide a number of additional benefits beyond the production of hydrogen. The hydrogen produced can be used by hydrogen consumers such as a hydrogen boiler for heating the building or buildings, and a fuel cell (such as a solid oxide fuel cell) for converting hydrogen to electricity for use in the building or for returning to the grid when there is an excess. The carbon produced in the process can be used directly to address the significant practical issue of waste management. The environmental impact of new developments is now assessed carefully, and the effect of groundwater contaminants (such as nitrates, nitrites and phosphates) carefully considered. By depositing carbon into the sewage supply—particularly if this is done in the form of a fine powder with a very large surface area available for interaction, but without risk of clogging drainage channels—the hydrogen production system provides a system for removal of such contaminants from waste water. The result is effectively the same as in the use of activated carbon for removal of contaminants from groundwater. Use of this approach to hydrogen generation and consumption on site can therefore be used to reduce the environmental impact of new building developments significantly.

Existing uses of carbon for treatment of groundwater generally require a significant facility—typically the relatively long residence time for removal of contaminants requires use of a large basin and the use of stirring or agitation mechanisms. The use of the sewerage system effectively provides these conditions without the need for developing a separate facility—the sewer system provides a large volume for interaction between carbon and wastewater, and the normal action of the sewerage system promotes this interaction.

For preference, methane is used as the hydrocarbon in this system. Methane is abundant and is of significant concern as a greenhouse gas both in itself and if combusted (as carbon dioxide is a reaction product). Using a plasma torch to decompose methane into carbon and hydrogen removes greenhouse gases from the system—hydrogen can be used without resulting harmful reaction products, and the carbon can be used for environmentally positive purposes. Providing methane in the built environment is relatively straightforward, requiring less infrastructural adaptation than provision of hydrogen.

### BRIEF DESCRIPTION OF FIGURES

Embodiments of the invention will now be described, by way of example, with reference to the accompanying Figures, of which:

FIG. 1 shows a building equipped with systems according to embodiments of the invention;

FIG. 2 shows an exemplary hydrogen production system for use in FIG. 1 in more detail;

FIG. 3 shows a longitudinal cross-section of a plasma torch from an exemplary hydrogen production system;

FIG. 4 show a detail from the plasma torch of FIG. 3 showing additional elements of the anode, and illustrating features that prevent carbon build-up;

FIG. 5 shows flow of reaction gases through the plasma torch of FIG. 3;

FIGS. 6A and 6B show side elevation and sectional views respectively of a ring for inlet of feedstock gases for use in the plasma torch of FIG. 3;

FIG. 7 illustrates a reaction process for a reactor structure suitable for use as a hydrogen production system for embodiments of the disclosure;

FIG. 8 illustrates a liquid metal pyrolysis reactor system driven by the plasma torch system of FIGS. 3 to 7 and including a housing for the plasma torch system;

FIGS. 9A and 9B illustrate the liquid metal circulation system of the reactor of FIG. 8 driven by the plasma torch;

FIG. 10 illustrates the liquid metal pyrolysis reactor of FIG. 8 in more detail;

FIG. 11 illustrates feed systems to the liquid metal pyrolysis reactor of FIG. 10, together with a carbon output; and

FIG. 12 illustrates a process diagram for integration of a hydrogen production system according to embodiments of the invention into a built environment.

### DESCRIPTION OF SPECIFIC EMBODIMENTS

General and specific embodiments of the invention will be described below with reference to the Figures.

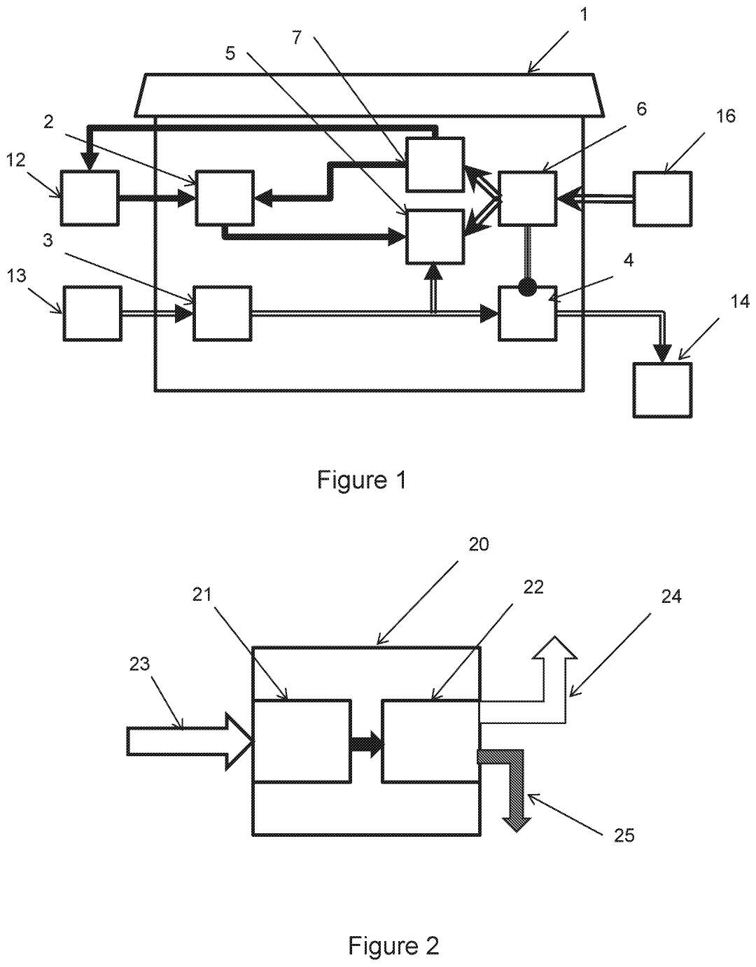

FIG. 1 shows an exemplary building and building systems suitable for use with embodiments of the invention. A building 1 has an electrical system 2 fed from the electricity grid 12 and a water system 3 fed from a water supply 13 and draining from a drainage system 4 into an external sewage system 14. The building 1 has a heating system 5—in this case, the heating system 5 is hydrogen powered, and is fuelled from a hydrogen production system 6. The hydrogen production system 6 accepts a hydrocarbon input—here shown from a mains gas supply 16. The system shown here also employs a fuel cell 7 for conversion of hydrogen into electricity—this may be used to contribute to powering the building through the electrical system 2, and it may also contribute to the electricity grid 12.

The approach shown in FIG. 1 involves hydrogen production on site. As hydrogen is both more challenging to transport and to store than natural gas, there is already some advantage in doing this. There is a further benefit in local production of hydrogen by pyrolysis of hydrocarbons, in that carbon black is a by-product, and this can be used locally in the built environment as will be described further below. Local production of hydrogen also allows local control of energy production, which has benefits which are also discussed below. FIG. 2 shows schematically a pyrolysis reactor 20 which has a reactor stage 21 and a separation stage 22—the reactor stage 21 accepts a hydrocarbon input 23 and the reaction products are fed to the separation stage 22, where the reaction products are separated and provided at a hydrogen output 24 and a carbon output 25.

The hydrocarbon provided through the hydrocarbon input 23 may be methane—as methane is a polluting gas, conversion of methane to carbon and hydrogen has a clear environmental benefit, as hydrogen burns without a polluting by-product. The reactor stage 21 may comprise a plasma torch reactor used to decompose methane, and the separator stage 22 may comprise a liquid metal system to carry reaction products away from the plasma torch and to provide them to separate outputs. As is further discussed below, a more complex reactor arrangement is possible—for example, the liquid metal stage may have both a reactor and a separation function.

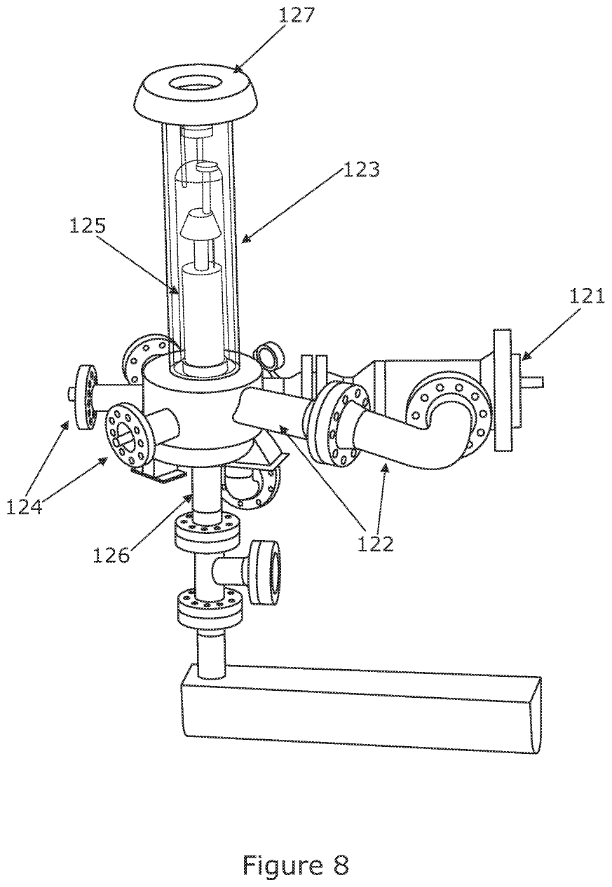

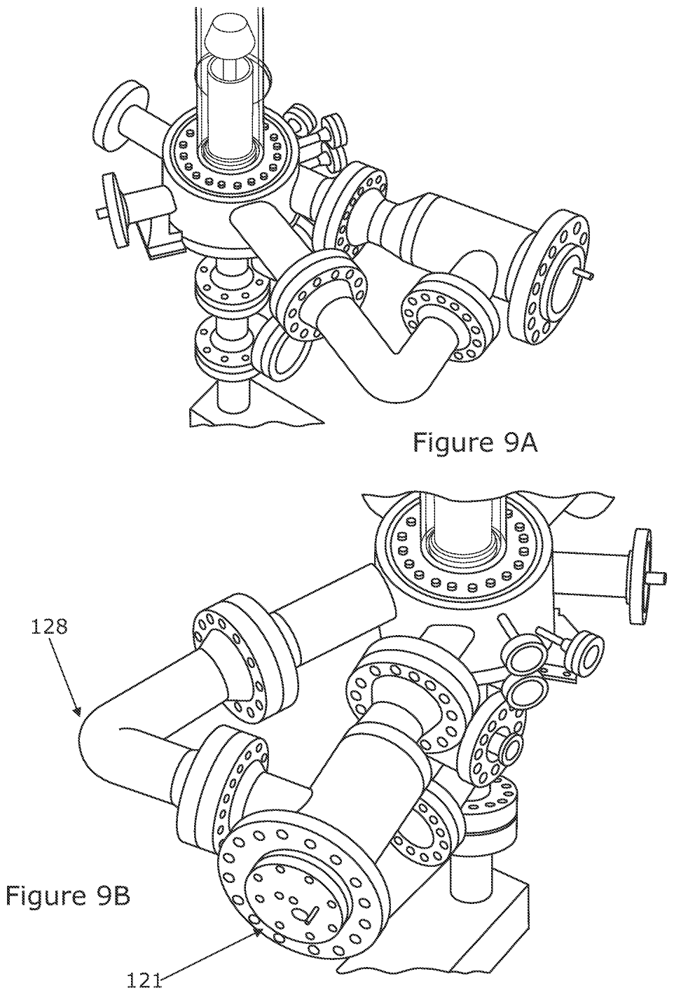

A particularly suitable embodiment of a hydrogen production system will now be described—this approach uses a plasma torch to separate methane into hydrogen and carbon, and a liquid metal system to remove the hydrogen and carbon for separation into a hydrogen gas output and a solid carbon output. A reactor using this approach will now be described. The reactor is formed as a pressure vessel with electrical inputs to power a plasma torch or torches (further detail is provided in FIG. 8) and gas inputs for gaseous feedstocks to be admitted to the system. The reactor shown here may have multiple stages—the plasma torches act as a first reactor stage, with the liquid metal potentially acting as a further reactor stage consuming heat generated by the plasma torches. The reaction products include heated gas—hydrogen in the main example discussed below—and a heat exchanger may use the heated gas to bring feedstock gases to the correct temperature for reaction, effectively acting as a preliminary reactor stage.

In the multi-stage reactor approach, gaseous inputs—for example, hydrocarbons such as methane, and potentially additional hydrogen for cooling (though this may be recirculated from the output products)—are admitted into the plasma torch, and the plasma torch consumes the input feedstock gases providing a first set of output products, such as carbon and hydrogen. These first output products pass at high temperature as inputs into a liquid metal reactor, which then provides pyrolysis of further feedstock gas. Final output products—such as carbon, extracted through the liquid metal, and hydrogen, output as a gas—are provided from liquid metal reactor after a separation process—these final output products include the first output products from the plasma torch along with further output products produced from pyrolysis in the liquid metal reactor. The pyrolysis reaction is endothermic, but there is still sufficient heat present that the gaseous final output products are at significantly greater temperature than desired for storage, so there is excess heat to be used. Here, this heated gas output is used by a heat exchanger which controls the temperature of feedstock gases for different stages of the reactor process. As will be noted further below, this multi-stage reactor is only an exemplary hydrogen production system—embodiments of the invention may not require all the features described for the multi-stage reactor.

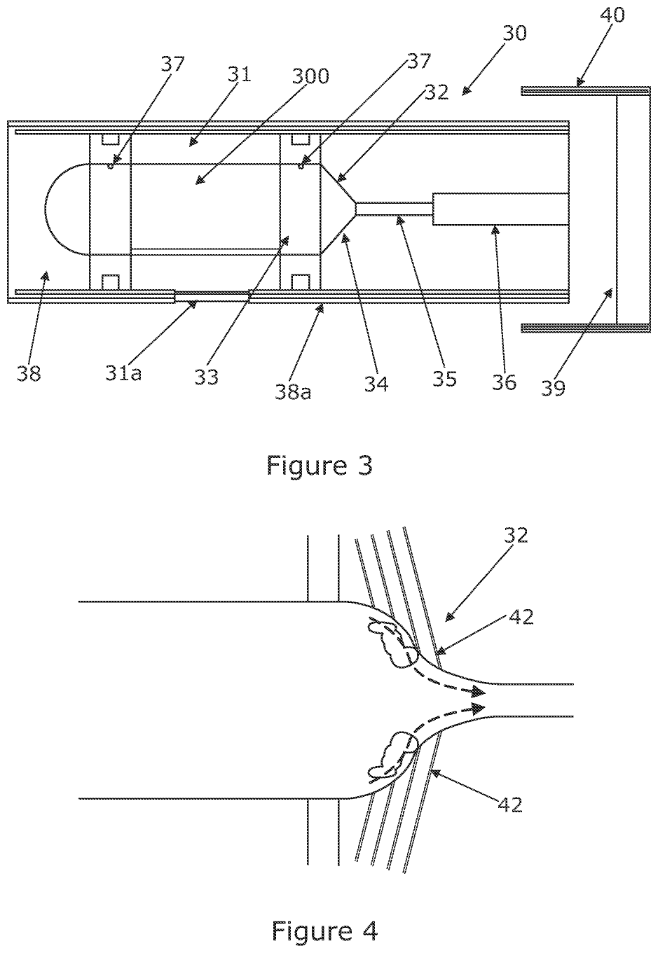

The plasma torch is shown in more detail in FIGS. 3 to 5. A longitudinal sectional view of the plasma torch 30 is provided in FIG. 3. The plasma torch 30 is generally cylindrical, and in the arrangement used in embodiments of the invention, it extends into a liquid metal circulation system 40 (discussed further below) where it jets directly into the liquid metal. The plasma torch has a central chamber 300 containing a cathode 31 and an anode 32. These may be of any conductive material suitable for the conditions in the central chamber 300—carbon (graphite) could be used, or any suitable metal or alloy, either uniform or with suitable inserts—for example, copper with hafnium inserts would be a possible choice. Here, the cathode 31 is located towards the end of the plasma torch 30 remote from the liquid metal reactor 39, with a ceramic cup-shaped end section 38 terminating the plasma torch. In alternative torch designs, the electrodes may be disposed the other way around, or an alternating current plasma torch may be used in which it is only meaningful to talk of electrodes, rather than anode and cathode. The anode is generally cylindrical, but it has a shaped inner surface 34 which comprises a nozzle 35 and a diffusing section 36, which will be described in greater detail below. A protective electrode 33 may be disposed between the cathode 31 and the anode 32—the skilled person will appreciate that again the electrode structure may be varied to achieve a desired field pattern within the plasma torch chamber, and may involve none, one or multiple intermediate electrodes—multiple protective electrodes may be cascaded to help stabilisation of the spark, for effective ignition, or to prevent wear on the anode. Gas inputs 37 are provided to admit gaseous feedstock into the reactor—in the arrangement shown in FIG. 3, methane is admitted in the gas input 37 disposed in the protective electrode 33. As will be indicated in further detail below, different gas input positions are provided for different feedstock gases in different embodiments of the invention. While the discussion below will refer primarily to methane, it should be appreciated that other hydrocarbons may equally well be used—for example, propane can be transported in liquid form but will vaporise easily for reaction in a plasma torch reactor, so will be another particularly suitable choice for processing.

FIG. 4 illustrates one phenomenon in the use of the plasma torch 30 shown in FIG. 3 to break down methane. In this reaction, methane decomposes at high temperature into hydrogen gas and carbon through action of the plasma torch spark, which may have a temperature of 6000 degrees Centigrade, resulting in instant decomposition. A practical issue is that this may result in carbon deposits 41 which would clog the torch, which will significantly affect the efficiency of the process, and which could lead to significant downtime for maintenance. It would be desirable to prevent such carbon build up, and for both reaction products to exit the plasma torch 30. One feature to achieve this is to protect the anode with a gas that will inhibit build up. This can be achieved by making the anode 32 porous, with anode gas outputs 42 delivering gas—in this case, hydrogen, through the anode to provide a protective curtain along the inside of the anode, inhibiting carbon build up. The gas is delivered at an angle to the anode such that it has a component of velocity towards the plasma torch output to achieve this protective curtain—alternatively, a component of velocity can be provided away from the plasma torch output, as this will still provide a protective curtain to the electrode. In addition to providing a protective curtain, there may also be active erosion of deposited carbon by the hydrogen—the hydrogen can react with the carbon in a back reaction back to methane, thus further eroding any carbon deposited. The hydrogen also serves to cool the anode, preventing it from being degraded. In addition to using a porous anode in this way, the cathode can also be made porous and cooled in a similar way.

Further strategies are used to prevent carbon build-up. The shaping of the anode can also be arranged such that a likely deposition point for carbon would be on the anode in the region of the spark gap with the torch in operation—spark action can then further erode any carbon build-up.

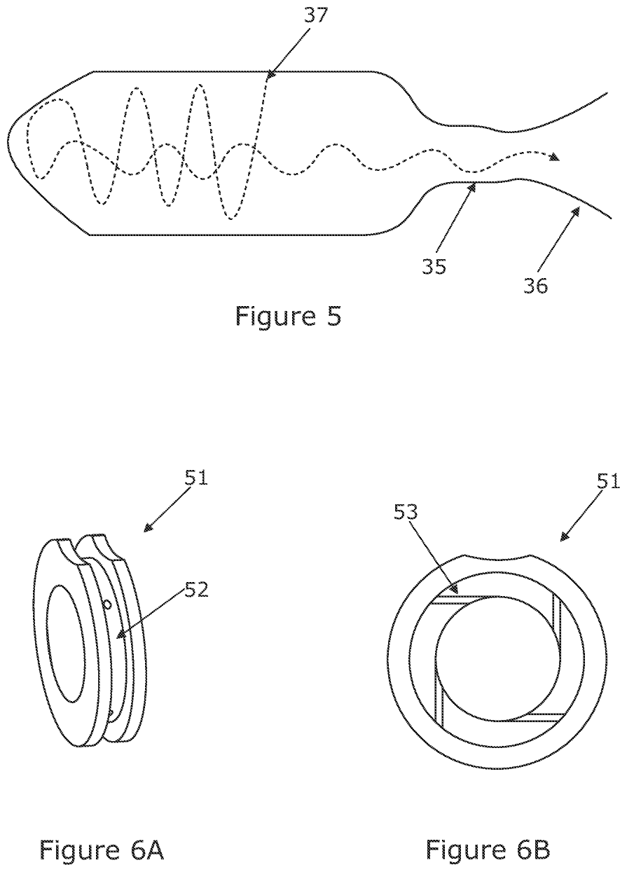

Another feature that prevents carbon build up is shown in FIG. 5, which illustrates the passage of gas through the plasma torch structure. Here, methane enters the plasma torch tangentially through the gas input 37 in the protective electrode, and this input methane travels towards the cathode following a generally helical path. The gas input 37 here is provided through a ceramic ring 51, shown in more detail in FIGS. 6a and 6b. The ceramic ring 51 has a gallery 52 for circulation of the input gas around the ring, allowing the input gas to pass into a number (four in the design shown) of channels 53 which deliver input gas tangentially into the chamber, establishing both a helical path in the output gas adjacent to the wall of the chamber and also a vortex within the plasma torch chamber. This may be optimised taking into account gas type, flow conditions, pressure and temperature to achieve the desired flow pattern. The wall structure (in particular wall roughness and geometry promotes the outer helix of gas maintaining its momentum and separating from the faster rotating inner helix of gas, with the torch geometry forcing the gas into an inner returning helix at a greater speed and with a tighter inner circle. The gas adopts this tighter helix on travelling back between cathode and anode, and it maintains this on heating as it is broken down into carbon and hydrogen in the spark gap between the cathode and the anode. Plasma formation is rapid—it will typically take less than a microsecond. For a gas, proper tuning allows this to be tuned (by pressure, temperature and density) to minimise exchange of energy between the helices, similarly to a tornado. This configuration already gives the output gas—in this case, hydrogen—significant velocity towards the output of the plasma torch, and it will also prevent carbon condensation and deposition, as the carbon is formed in the centre of the plasma torch chamber rather than at the walls. The plasma comprises ions and electrons in energetic balance in a state of near thermal equilibrium, with molecules largely decomposed into atoms—under operating conditions of temperature and pressure in the plasma torch, the stable state of carbon is as a gas, reducing likelihood of carbon deposition. The plasma torch design is generally arranged so as to promote the reaction in the centre of the chamber and to inhibit it at the walls, so that the reaction products are preferentially driven out of the plasma torch into the liquid metal reactor. The outer helix cools and insulates the wall, while preventing atomic carbon in the inner helix from condensing on the walls. The hydrogen from the reaction passes through the nozzle 35, which results in an increase in speed and a decrease of pressure according to the Venturi effect. The gas is then output from the plasma torch 30 through the diffuser 36 with high temperature (and kinetic energy)—the plasma is ejected from the torch at supersonic speeds. By the cumulative effect of these features, carbon is generally carried through into the plasma torch output without significant build-up of deposit on the walls of the anode. The role of the diffuser 36 is to match the pressure of the output of the plasma torch with the next reactor stage, as will be described in more detail below. As noted here, the embodiment described in detail here, the next reactor stage is a liquid metal reactor—the liquid metal here may also be used to interact directly with the torch, as will also be discussed further below.

This arrangement allows for operation at high temperature (above 6000 degrees Centigrade at the point of reaction) and hyperbaric pressure in the torch, with a very high throughput of gaseous feedstock. For an input of 200 kW of power into the plasma torch, and with operating temperatures within the torch chamber in the region of 6000 degrees Centigrade at the point of reaction and pressures of 50 bar, approximately 72 kg/hour of methane can be processed using this design. The voltage across the electrodes will typically be between 150V and 600V, typically about 250V, with operating current between 100A and 500A, typically about 200A. Feedstock gases can be pre-heated by using a heat exchanger—taking advantage of the heat given out in the pyrolysis reaction (see further discussion below), though hydrogen used to cool the anode will be provided at a lower temperature.

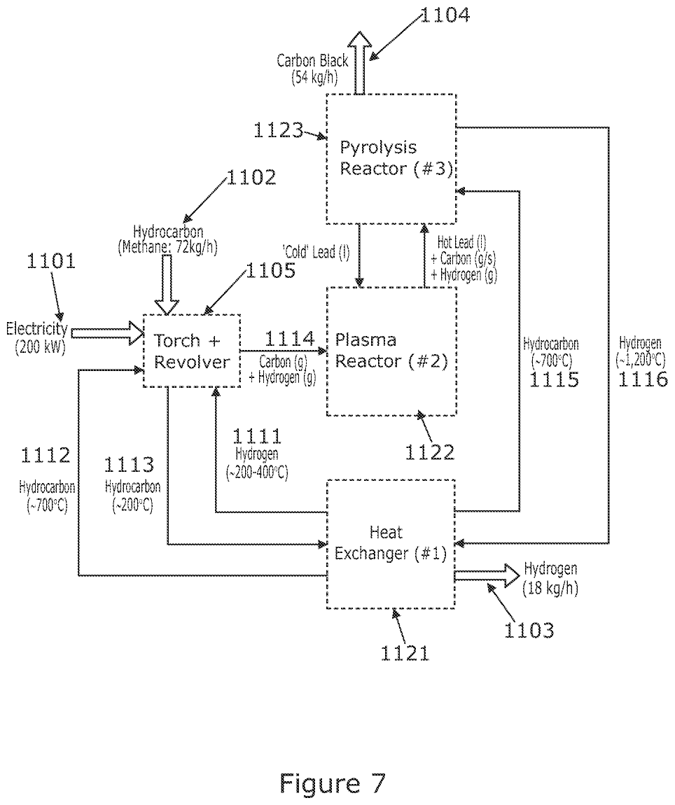

Before describing the other elements of the reactor, an overall reaction flow for the multi-stage reactor will be described with respect to FIG. 7. This reaction flow is specific to decomposition and pyrolysis of methane, but it is used here more generally to illustrate the different reaction processes taking place in different parts of the composite reactor. For example, other hydrocarbons such as propane may be used as a feedstock hydrocarbon, rather than methane, in not only the plasma torch reactor but also the liquid metal reactor.

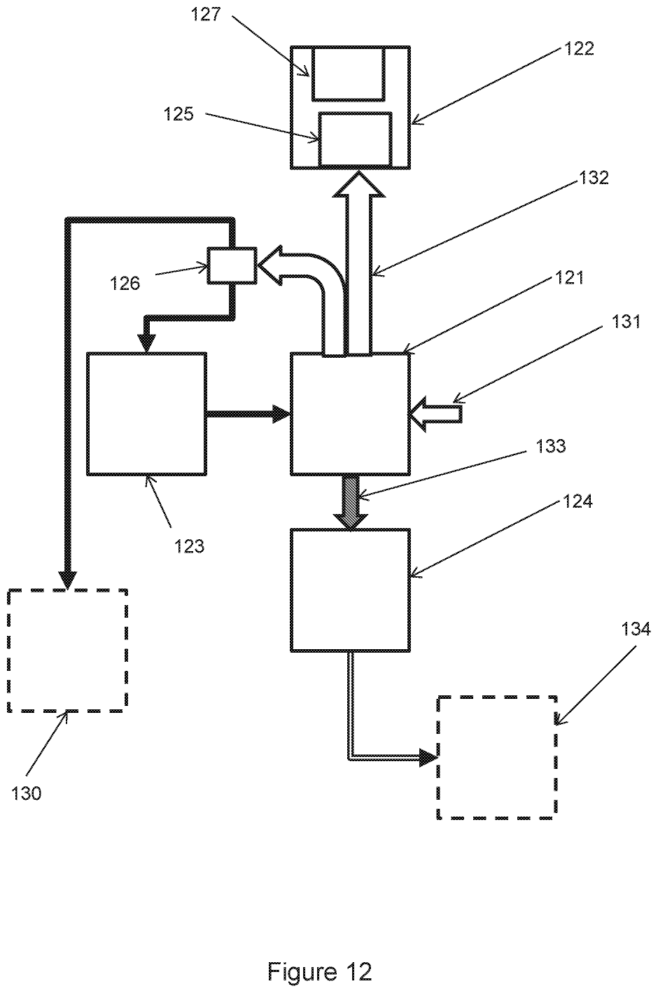

Two inputs to the system are shown: electricity 1101 and hydrocarbon 1102 (in this case, methane). Two outputs are shown: hydrogen 1103 (though for other reactions, other output gases may be provided as well or instead—note also that some of the hydrogen generated is recirculated for use in the reaction processes) and carbon black 1104. These outputs are put to different uses, as will be indicated further below with reference to FIG. 12. Both inputs are provided to the plasma torch 1105—in addition to electrical power and the hydrocarbon feedstock, hydrogen is provided as an input. In the arrangement shown, a low temperature hydrogen input 1111 (shown here in the 200-400 degree Centigrade range) is provided to the plasma torch 1105 for cooling the anode, for example, with high temperature hydrocarbon 1112 (shown here at around 700 degrees centigrade), used as a reaction feedstock and also to maintain the temperature and pressure of the reaction chamber and to promote the flow of material through the plasma torch. As the plasma torch consumes electrical energy and generates a high temperature output, this is partially consumed by the pyrolysis reaction in a second reactor 1122, from which heated output gases can be used in a heat exchanger 1121 to circulate the hydrocarbon feedstock so that it is elevated from low temperature hydrocarbon 1113 at about 200 degrees Centigrade to high temperature hydrocarbon 1112 at a plasma torch reaction temperature of about 700 degrees centigrade—the heat exchanger 1121 can also provide hydrogen at cooler temperatures to the plasma torch. This heat exchanger 1121 thus effectively acts as a first reactor process, absorbing the heat of the end process and using it to bring gases required for reaction stages to the correct temperature.

The plasma torch 1105 itself acts as a second reactor 1122, providing high temperature hydrogen and (primarily) gasified carbon as outputs 1114. The plasma torch 1105 through its reaction products operates on the next reactor stage, which is a liquid metal pyrolysis reactor 1123. The plasma torch 1105 provides heat for this reaction, heating up the metal (here, lead) to reaction temperature, and also providing rotation to the lead, allowing the carbon to be extracted at the centre of the reactor. More high temperature hydrocarbon 1115 is provided from the heat exchanger 1121 as a feedstock for the liquid metal pyrolysis reactor 1123. The hydrogen output 1116, provided at very high temperature (approximately 1200 degrees Centigrade) from the exothermic reaction in the pyrolysis reactor, is returned to the heat exchanger 1121 and partly recirculated to the plasma torch 1105 while mainly provided (at a lower temperature) at the hydrogen gas output 1104.

The liquid metal pyrolysis reactor is shown in more detail in FIGS. 8 to 11. FIG. 8 illustrates the main elements of the reactor assembly. The torch mounting 121 is directed into a liquid metal racetrack 122 which feeds into the main reactor volume 123. There are also gas inputs 124 to the main reactor volume 123, which contains a swirl chamber 125.

The liquid (molten) metal is delivered into the swirl chamber 125 so as to give rotation to the liquid metal column, allowing the liquid metal both to initiate a pyrolysis reaction in the input gas and to act as a centrifugal separator, separating reaction products towards the centre of the rotating column. Carbon is then extractable from the base of the reactor in a carbon output 126. Hydrogen rises from the liquid metal and is released through a hydrogen output 127 from the top of the reactor. The reaction is carried out at elevated temperature and pressure (typically 800-1000 degrees Centigrade and 50 bar).

This functionality may be usefully combined with that of the plasma torch even if the liquid metal system is not itself a reactor—in that case, it only acts as a separator to separate the reaction products from the plasma torch, powered by the energy of the plasma torch output. This leaves significant excess heat, however, and it is found that making the liquid metal system itself a reactor, used for endothermic pyrolysis of further hydrocarbon, leads to a particularly effective reactor system.

FIGS. 9A and 9B show the plasma torch mounting and the liquid metal racetrack from different angles. Liquid metal passes out of the reaction chamber as it cools and reaction products are separated, and it then passes through a liquid metal racetrack 122 past an elbow joint 128 towards the plasma torch mounting 121, where the plasma torch output is jetted into the liquid metal. This heats the liquid metal up to a sufficient temperature to initiate a pyrolysis reaction in hydrocarbons such as methane, and also carries the reaction products of the plasma torch reaction into the liquid metal reactor so that they can be collected from the system (methane passing into the liquid metal from the plasma torch jet may also be pyrolyzed at this point). The heated metal passes along the rest of the liquid metal racetrack and enters the liquid metal reactor chamber from the bottom. The parts of the racetrack structure as a result need to withstand high temperatures from the heated liquid metal, and they will also need to be adapted for expansion from the significant difference between temperatures during reaction processes and outside reaction processes. Joints may for example be protected by use of molybdenum sleeves.

The plasma torch is designed so that it will jet effectively into the liquid metal racetrack 122—in particular, the diffuser of the plasma torch is designed to match pressures with the outside of the torch. This will have the benefit of supporting linear rather than turbulent flow in the liquid metal racetrack. The liquid metal may be brought into a swirl or vortex which will act to stabilize the plasma jet. Reaction products from the plasma torch—in the example shown, hydrogen and carbon—will be carried in the liquid metal for subsequent separation in and output from the liquid metal reactor, as described below.

The liquid metal system may also serve to purge the outputs of the plasma torch reactor from impurities. For example, ethylene may be produced as a by-product but then be broken down again in the liquid metal system. The liquid metal from the liquid metal system may have other functions. For example, the diffuser of the plasma torch may extend sufficiently far into the liquid metal racetrack that the liquid metal will act to clean the diffuser and prevent carbon build-up there—in embodiments, the diffuser section may be porous in part to support liquid metal flow. If desired, the liquid metal from the racetrack could even be driven up to flood the plasma torches, rapidly quenching the reaction and stopping their operation. Liquid metal could thus be used to flood—and hence clean—the porous anode (and where used, cathode) structures.

Lead, or a mixture primarily containing lead, may be used as the liquid metal in the liquid metal system. Lead is a suitable choice as it is liquid at reaction temperatures without having a high vapour pressure, and it creates fewer toxicity issues than most other suitable metals. Gallium is another possible choice.

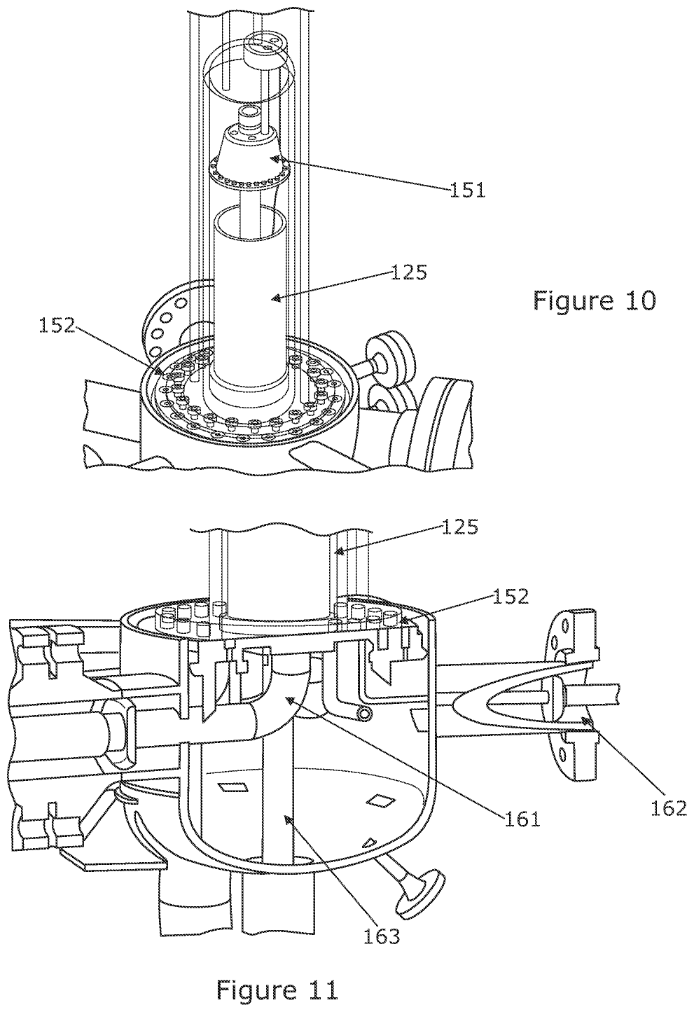

As noted above, the liquid metal system is here designed in this structure to act not only as a separator but also as a reactor. FIG. 10 provides a view of the swirl chamber 125 which forms the reaction chamber for the liquid metal pyrolysis reactor. Heated liquid metal is passed into this chamber from below along with input gases, and circulation within the swirl chamber 125 leads to separation with the reaction products separated by centrifugal action into the centre of a circulating liquid metal column, with carbon and hydrogen initially collected in a hat structure 151 at the top of the reactor. This can be used to collect clean hydrogen—this will be the only gas at this point and can simply be released through a float valve. A liquid salt structure can be provided in this structure for the lead and carbon mixture to percolate through—this will separate out the carbon from the lead, with the process being completed by gravity with the lighter carbon floating up over both the lead and the salt, which are heavier. This enables the carbon to be separated by dropping it through a chute in the central region of the chamber. The base plate 152 beneath the swirl chamber 125 has through holes for gaseous inputs. Cooling metal passes out through holes in the side of the swirl chamber 125 and down through the base plate 152 where it circulates on to the liquid metal race track shown in FIGS. 13 and 14.

Further details of the swirl chamber 125 are shown in FIG. 11. FIG. 11 shows the lower part of the liquid metal reactor vessel, beneath the swirl chamber 125 in which the reaction takes place. Hot metal heated from the plasma torch enters from below through metal inlet 161 with reaction gases entering through gas inlets 162. Carbon is output through the bottom of the reactor in carbon output 163. Hydrogen is circulated down through the base plate 152 of the swirl chamber 125 for subsequent circulation and collection above the swirl chamber.

As has been described above, a heat exchanger system is provided which allows the heat generated in reaction to be used to provide input gases at the correct temperature for use in the reaction. The hydrogen output from the liquid metal reactor, which is at high temperature (1200 degrees Centigrade) is used to heat up methane feedstock for provision to both the plasma torch and to the liquid metal pyrolysis reactor. A part of this hydrogen output is cooled to a much lower temperature (for example 200 to 400 degrees Centigrade) and used to cool the anode and the cathode of the plasma torch, as described above.

While the reactor embodiment described here is adapted for pyrolysis of methane, this reactor structure can be employed for a number of reactions. As noted in the discussion of the feedstock system, for example, a variety of input gases may be used in different reactions, with input positions of gases chosen to achieve the correct circulation of gases throughout the plasma torch. Similarly, different inputs may be provided to the liquid metal reactor, rather than simply methane, to achieve different reactions.

It should be emphasised that the specific reactor structure described above is exemplary only of a hydrogen production system for use in embodiments of the invention. In particular, a multistage or composite reactor structure is not required—what is needed is an effective way to produce hydrogen and appropriately formed carbon at an appropriate scale, which can be achieved by use of a plasma torch for separation of hydrocarbon into hydrogen and carbon together with a liquid metal system to achieve effective separation.

FIG. 12 shows how the hydrogen production system 121 integrates into the built environment systems, which include a heating system 122, an electrical system 123, and a sewage disposal system 124. The hydrogen production system has a hydrocarbon input 131 along with an input from the electrical system, and it provides a (gaseous) hydrogen output 132 and a (solid) carbon output 133. The hydrogen output 132 passes to one or more hydrogen consumers—these here comprise a hydrogen boiler 125 and a fuel cell 126. The hydrogen boiler 125 drives the heating system 122—this may be used both to drive the heating system 122 to heat the built environment, but also for energy storage (for example, in hot water tanks 127). The fuel cell 126 is used to convert hydrogen into electricity—this may be used directly by the electrical system 123, but it may also be provided to the external electrical grid 130. The carbon output 133 is provided to the sewage disposal system 124, where it acts to remove contaminants such as nitrites, nitrates and phosphates from the waste water system 134 to which the sewage disposal system 124 connects. Exemplary operation of the separate parts of this system are described further below.

The size of hydrogen production system will need to be appropriate to the built environment in which it is located—a system adapted to provide a 3 kW power output (through the hydrogen consumers) would be appropriate to meet the needs of a normal household (with energy demand of about 1 KW)—larger outputs would be needed for larger buildings or sets of buildings. Hydrogen production systems of the kind indicated above are highly scalable, so it will be possible to design a system appropriate to the requirements of the building in which it is located.

Hydrogen and hydrogen-ready boilers are currently undergoing full commercial development, with boilers at the prototype stage at least developed by Worcester Bosch, Viessman and Baxi, with some prototype boilers able to operate on a full hydrogen supply and others on a natural gas and hydrogen mix. A solid oxide fuel cell may be appropriate for use as a hydrogen consumer in this system—the skilled person will be aware of what fuel cell will be appropriate for use here for a hydrogen supply of the type indicated. The fuel cell may be run to provide electricity for the building or buildings, or for provision of electricity to the electrical grid. This can be used as a balancing mechanism, both locally and more widely to compensate for variability of a renewable-dominated set of sources for power supply to the electricity grid—hydrogen can be consumed by the boiler when electricity prices are low, but it can be consumed by the fuel cell to provide power to the grid when electricity prices are high.

For a 3 kW system of the type described, the carbon output will be of the order of 500 g per hour. The size of carbon output can be controlled to some degree by adjusting parameters of the process used to create it, but sizes will typically be of the order of 0.05-0.5 microns.

This is of comparable size to powdered activated carbon, which is already used to treat groundwater contamination. Contaminants such as nitrites, nitrates and phosphates are loosely bound to the carbon, which has a very high contact area enabling significant adsorption of such materials. The dwell time of the carbon in sewage systems is likely to be of the order of hours, providing good opportunity to adsorb material. The fine nature of the material means however that it is unlikely to block sewage systems, even downstream systems that are not specifically designed to receive materials of this type. The carbon acts as a filter effective to reduce the level of contaminants in groundwater—this may, for example, be necessary to enable developers of new properties to meet environmental impact requirements for a relevant development.

As the skilled person will appreciate, the approach taken here does not rely on the use of a specific type of hydrogen production system, provided that hydrogen and carbon are provided as outputs. The skilled person will also appreciate that variations can be made to this approach without digressing from the fundamental concept described here—for example, an alternative output gas to hydrogen could be produced by a modified “hydrogen production system” to power the heating system.

1. An energy provision system for a building or system of buildings, the system comprising:
a hydrocarbon processing system adapted to provide a hydrogen gas output and a carbon solids output from a hydrocarbon input;
wherein the hydrogen gas output is provided to one or more hydrogen consumers for providing energy; and
the carbon solids output is provided to a waste water system for removing contaminants or pollutants from waste water.

2. The energy provision system of claim 1, wherein the hydrocarbon processing system comprises a pyrolysis reactor.

3. The energy provision system of claim 2, wherein the pyrolysis reactor comprises:
a plasma torch reactor for processing hydrocarbons, wherein the plasma torch reactor has a hydrocarbon gas input and a hydrogen and carbon gas output; and a system for receiving the hydrogen and carbon gas output from the plasma torch reactor, and for conveying the hydrogen and carbon to a separation system for providing the hydrogen gas output and the carbon solids output.

4. The energy provision system of claim 1, wherein the one or more hydrogen consumers comprise a hydrogen-fired boiler.

5. The energy provision system of claim 1, wherein the one or more hydrogen consumers is adapted to provide electricity from a hydrogen input.

6. The energy provision system of claim 1, wherein the hydrocarbon input is a methane input.

7. A method of operating a building or a system of buildings, the method comprising:
processing hydrocarbons from a hydrocarbon input to produce a hydrogen gas output and a carbon solids output;
providing the hydrogen gas output to one or more hydrogen consumers for providing energy; and
providing the carbon solids output to a waste water system for removing contaminants or pollutants from waste water.

8. The method of claim 7, wherein the one or more hydrogen consumers comprise a hydrogen-fired boiler for providing heating to the building or system of buildings.

9. The method of claim 7, wherein the one or more hydrogen consumers adapted to provide electricity from a hydrogen input.

10. The method of claim 9, wherein an electrical system of the building or system of buildings is configured such that electricity from the fuel cell may be provided to either the energy provision system, an electrical supply grid, or both.

11. The method of any of claim 10, wherein the processing of hydrocarbons comprises pyrolysis of hydrocarbons.

12. The method of claim 11, wherein the processing of hydrocarbons comprises pyrolysis using a plasma torch reactor with use of a system for receiving a hydrogen and carbon output from the plasma torch reactor and for conveying the hydrogen and carbon to a separation system for providing the hydrogen gas output and the carbon solids output.

13. The method of claim 12, wherein the hydrocarbons comprise methane.

14. The energy provision system of claim 3, wherein the system for receiving the hydrogen and carbon gas output is a liquid metal system.

15. The energy provision system of claim 5, wherein the one or more hydrogen consumers comprise a fuel cell.

16. The method of claim 7, wherein the one or more hydrogen consumers are for providing heating or power to the building or system of buildings.

17. The method of claim 9, wherein the one or more hydrogen consumers comprise a fuel cell.

18. The method of claim 12, wherein the system for receiving the hydrogen and carbon gas output is a liquid metal system.
